(19) United States
(12) Patent Application Publication
(10) Pub. No.: US 2022/0150277 A1
(43) Pub. Date: May 12, 2022

(54) MALWARE DETONATION

(71) Applicant: Microsoft Technology Licensing, LLC, Redmond, WA (US)

(72) Inventors: Tal Joseph Maor, Seattle, WA (US); Guy Pergal, Herzliya (IL); Moshe Ben Nehemia, Givat Shmuel (IL)

(73) Assignee: Microsoft Technology Licensing, LLC, Redmond, WA (US)

(21) Appl. No.: 17/095,385

(22) Filed: Nov. 11, 2020

(51) Int. Cl. H04L 29/06

(52) U.S. Cl. CPC H04L 63/1483; H04L 63/20; H04L 63/0892; H04L 63/0876

(57) ABSTRACT

A system to detonate malware received from a delegated access link provided to a user is disclosed. An application is received via a delegated access link provided to the user. A verdict is determined on the delegated access link. If the verdict on the delegated access link is unknown the application is opened in a laboratory user based on the user, and activities of the application are monitored. A verdict on the delegated access link is determined based on whether monitored activities include suspicious activities.

### BACKGROUND

In the context of information security, social engineering includes the manipulation of people into performing actions such as divulging confidential information. One example of social engineering is phishing, which includes the fraudulent attempt to obtain confidential or sensitive information such as usernames, passwords, bank card details, by disguising the fraudulent actor as a trustworthy entity often in an electronic communication. Often carried out with an electronic communication such as email, instant message, or text message, phishing can direct a target user to enter personal information at fake websites that may match or mimic the look and feel of a legitimate website. Fraudulent actors lure target users by purporting to be trusted parties such as social websites, auction sites, banks, colleagues, online payment processors, or information technology administrators. For example, phishing may sue some form of technical deception to make a link, or reference to a web resource, in an electronic communication appear to belong to a trustworthy entity. The link, and the website to which it refers, are a hoax or spoofed website. The link may include misspellings or subdomains or a text link that refer to the spoofed website. Phishing scams may also use JavaScript commands to alter the address bar of the website to which they refer.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

A system to detonate malware received from a delegated access link provided to a user is disclosed. For example, a delegated access link to an application can to a valid application or malware from, for example, a phishing scam. An application is received via a delegated access link provided to the user. A verdict is determined on the delegated access link. Verdicts can include prohibit access to the link, which will not permit authorization of the delegated access link, and permit access to the link, which will provide authorization. The verdicts corresponding with the applications associated with the links can be stored in a stored in a database. If the verdict on the delegated access link is unknown the application is opened in a laboratory user based on the user, and activities of the application are monitored. A verdict on the delegated access link is determined based on whether monitored activities include suspicious activities. For example, the activities are monitored over a period of time with a security policy, and suspicious activities include activities that run afoul, or violate, the security policies. The determined verdict can be added to the database.

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessarily to scale relative to each other. Like reference numerals designate corresponding similar parts.

FIG. 1 is a block diagram illustrating an example of a computing device, which can be configured in a computer network to provide, for example, a cloud-computing environment.

FIG. 2 is a block diagram illustrating an example computer network such as a cloud-computing environment that can be implemented with the computing device of FIG. 1.

FIG. 3 is a block diagram illustrating an example method that can be implemented with the example computing network of FIG. 2.

FIG. 4 is a block diagram illustrating an example security system that can implement a feature of the computer network of FIG. 2.

FIG. 5 is a block diagram illustrating an example method of the security system of FIG. 4.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

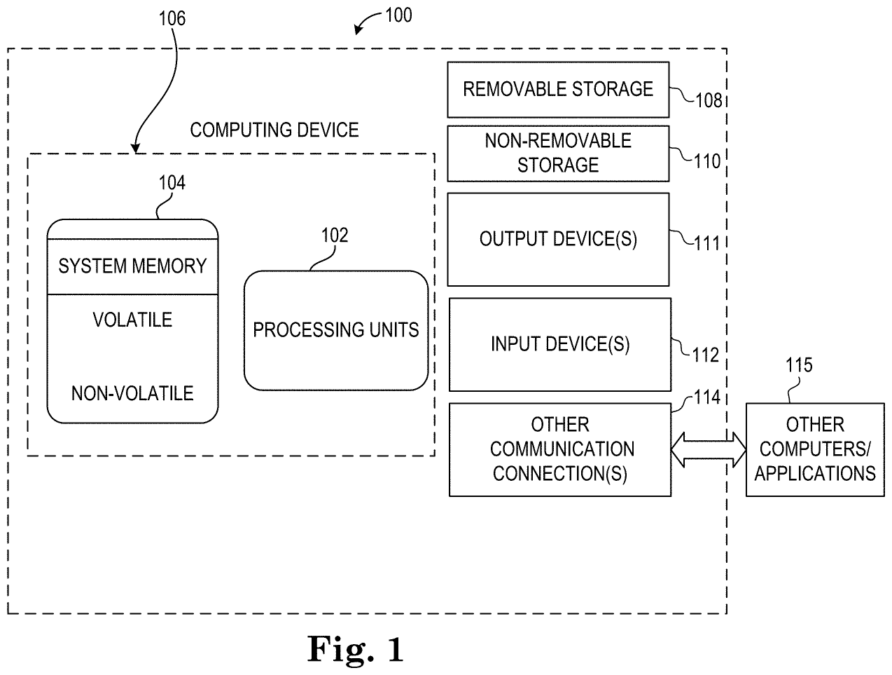

FIG. 1 illustrates an exemplary computer system that can be employed in an operating environment and used to host or run a computer application included on one or more computer readable storage mediums storing computer executable instructions for controlling the computer system, such as a computing device, to perform a process. The exemplary computer system includes a computing device, such as computing device 100. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network.

In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two.

Computing device 100 can also have additional features or functionality. For example, computing device 100 may also include additional storage. Such storage may be removable or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse, track pad), stylus, voice input device, touch input device (e.g., touchscreen), or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the internet, or other network.

In one example, one or more of computing device 100 can be configured as a client device for a user in the network. The client device can be configured to establish a remote connection with a server on a network in a computing environment. The client device can be configured to run applications or software such as operating systems, web browsers, cloud access agents, terminal emulators, or utilities.

In one example, one or more of computing devices 100 can be configured as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices. Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform. Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment. In other examples, the provider can offer a combination of infrastructure and platform services to allow a consumer to manage or control the deployed applications as well as the underlying cloud infrastructure. Platform as a service providers can include infrastructure, such as servers, storage, and networking, and also middleware, development tools, business intelligence services, database management services, and more, and can be configured to support the features of the application lifecycle including one or more of building, testing, deploying, managing, and updating.

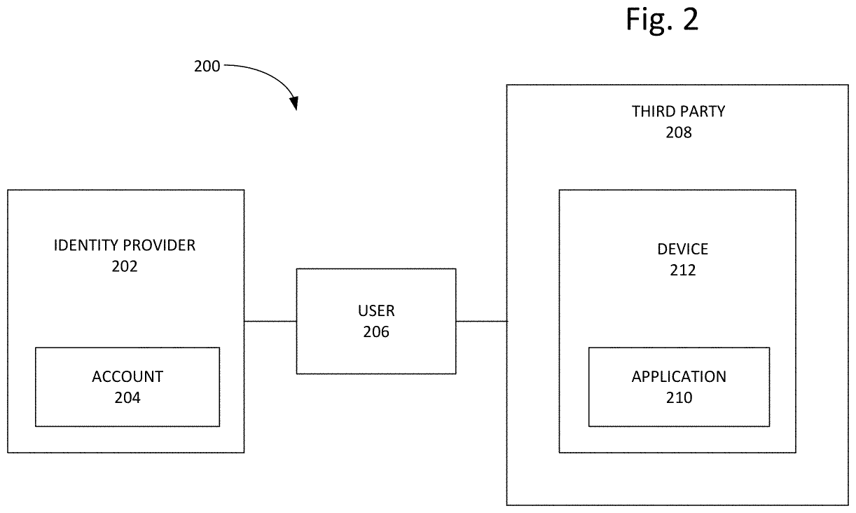

FIG. 2 illustrates an example a computer network 200, such cloud-computing environment, to detonate malware received from a delegated access link provided to a user. In the illustrated example, an identity provider 202, such as an identity provider system of computing devices, can include a client account 204 associated with a user 206, such as a plurality of client accounts associated with users, coupled to the network 200. In one example, the identity provider includes a delegated access service and can be delegated access provider. A third party 208, such as a third party computing device, can provide the user with a delegated access network link to a third party application 210 on an application device 212. In one example, the delegated access link is provided to authorize the user 206 via the client account 204 of identity provider 202 to access the third party application 210, such as a web application. A web application is a software application that runs on a remote server, such as the third party application 210 on the application device 212. In many cases, a web browser on a client device, or user 206, is used to access web applications, over the network 200, such as the internet. In some examples, third party applications can involve access to or integration with customer current data, such as data from client account 204 and data user may provide to the third party application 210, and in cases when such data are large in volume or sensitive, integrating the data with remotely hosted software can be costly or risky, or can conflict with data governance regulations.

Security service 220 provides services between the user 206 and the third party 208, which at times may be associated with a valid, or non-malicious, third party web application 210. In one example, the security service 220 may support multiple users of the identity provider 202, and can provide for users 206 to access multiple web applications, subscribed to or otherwise accessed by an enterprise. In some examples, security service 220 may be deployed on premises or accessed via a cloud service. In one example, the security service 220 may support multiple enterprises accessing one or more sets of applications in a multitenancy model of identity provider 202. Security service 220 can monitor activity between users 206 and the third party 208 and enforce security policies. For example, security service 220 may be included in a cloud access security broker to monitor user activity, warn administrators about potentially hazardous actions, enforce security policy compliance, and automatically prevent or reduce the likelihood of malware in the enterprise. In one example, the security service 220 is a distributed, cloud-based service.

In one example, the identity provider 202 is a system entity that creates, maintains, and manages identity information for principals and also provides authentication services to relying applications within a federation or distributed network. The identity provider 202 can offer user authentication as a service. For instance, web applications, such as application 210, can outsource the user authentication step to a trusted identity provider, such as identity provider 202.

In general, delegated access, or secure delegated access, is a mechanism that allows identity provider 202 to permit internet users 206, such as clients, access to third party applications 210 without sharing credentials. Identity provider 202 can include services with which the user 206 has an account 204. For example, identity providers can include social networks and identity and access management providers and web-based consumer services. The user, in one example, has an account 204 with the identity provider 202. In one example, delegated access can include authorization protocols, or pseudo-authentication, and authentication protocols. Identity providers 202 that implement delegated access can be referred to as delegated access providers. In one example, a user 206 has an account 204 with a delegated access provider that employs an authorization or authentication protocol. A third party 208 can provide access to a third-party associated application 210, such as a web application, via a link provided in an electronic communication to the client, such link can be referred to a delegated access link. The delegated access link can be used to authorize or authenticate the user 206 via the delegated access provider 202 to allow user access to the third-party associated application 210. An example of a delegated access protocol includes OAuth, such as OAuth 2.0 framework, which is an open standard published by the Internet Engineering Task Force in 2012.

In a valid application of delegated access, the user 206 requests a resource or site login from the application provided via a delegated access link. The third party 208 determines that the user 206 is not authenticated and formulates a request for the identity provider 202, encodes the request, and sends it to the user 206 as part of a redirect universal resource locator, or URL. The user's browser requests the redirect URL for the identity provider 202, including the application's request. The identity provider 202 can authenticate the user 206 (perhaps by asking the user 206 for a username and password. Once the identity provider 202 is satisfied that the user 206 is sufficiently authenticated, the identity provider 202 processes the application's request, formulates a response, and sends that back to the user 206 along with a redirect URL back to the application 210. The user's browser requests the redirect URL that goes back to the application 210, including the identity provider's response. The application 210 decodes the identity provider's response, and carries on accordingly. In one example, the response includes an access token which the application can use to gain direct access to the identity provider's services on the user's behalf. In an authentication use case, the response from the identity provider 202 is an assertion of identity; while in an authorization use case, the identity provider is also an application program interface, or API, provider, and the response from the identity provider is an access token that may grant the application ongoing access to some of the identity provider's API, on the user's behalf. The access token acts as a kind of “valet key” that the application can include with its requests to the identity provider, which prove that it has permission from the user to access the API.

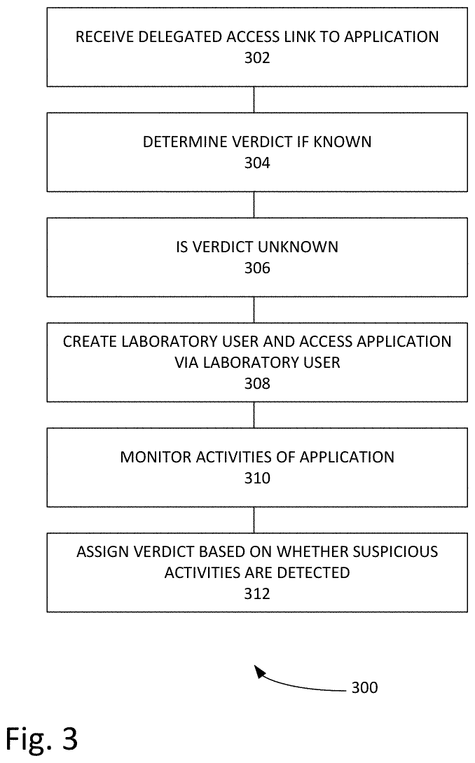

FIG. 3 illustrates an example method 300 provided by security service 220. The security service 220 can include a computer readable storage device to store computer executable instructions to control a processor, such as a server in a datacenter. In one example, method 300 can be implemented as a computer program to run a processor as part of a server, such as a server included in security service 220. The security service 220 receives a delegated access link to an application, at 302. In one example, the delegated access link was provided to the user 206 from third party 208, and is submitted to the identity provider 202, which provides the delegated access link to the security service 220. The security service can determine a verdict on the delegated access link at 304. For example, the security service 220 can maintain a denylist or blocklist of links or URLs that are prohibited and may also maintain a passlist or allowlist of links or URLS that are permitted via policies. For example, a verdict on the delegated access link can be one or more of permit access to the link or prohibit access to the link. Additionally, the verdict can be unknown, which is or includes that the link is neither on a denylist nor an allowlist.

If the verdict is unknown at 306, a laboratory user based on the user 206 is created, such as in the identity provider 202, and the application 210 is accessed via the laboratory user at 308. The activities of the application 210 are monitored at 310. In one example, the laboratory user is a form of honeypot in the identity provider 202, that provides an environment in which the application is run and the activities of the application 210 are monitored by the security service 210 for suspicious or malicious activities according to, for example, security policies. In one example, the activities of the application are monitored for a selected period of time. The laboratory user can be configured to elicit a varied range of activities. In other examples, the laboratory user can be configured to be passive. A verdict on the delegated access link can be assigned based on whether monitored activities include suspicious activities, such as activities deemed suspicious by security policies, at 312. For example, if the monitored activities include suspicious activities, the user 206 may be prohibited from accessing application 210 and the delegated access link is added to the denylist for other verdict determinations. If the activities do not include suspicious activities, such as the activities do not run afoul of security policies, the user may be allowed to access application 210. In some examples, the delegated access link may be provided to the allowlist for future verdict determinations.

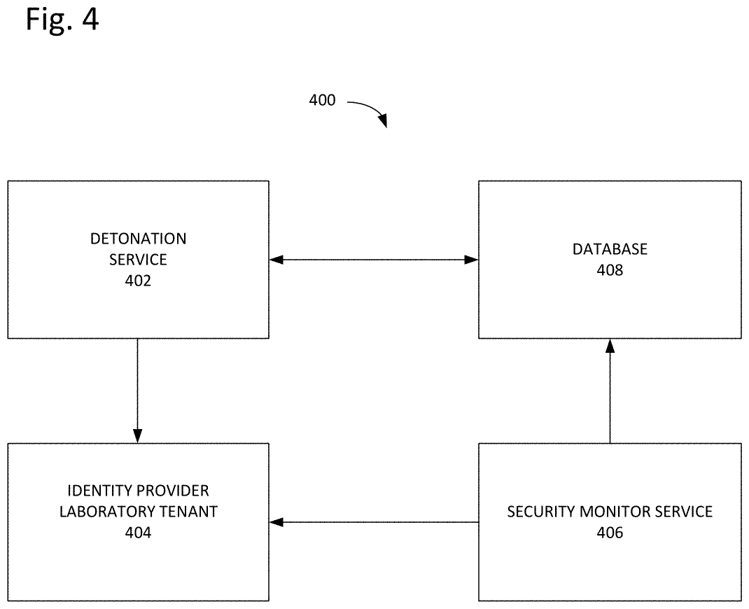

FIG. 4 illustrates an example system 400 to implement security service 220 and apply method 300. Features of the system 400 can be can be implemented a computer readable storage device to store computer executable instructions to control a processor, such as a server in a datacenter. System 400 includes a detonation service 402, an identity service laboratory tenant 404, such as a laboratory client or a plurality of laboratory clients with an identity provider, a security monitor service 406 to monitor activities and implement security policies, and database 408 to store delegated access links to malicious resources.

The detonation service 402 can be implemented to receive a delegated access link from a third party and can receive URLs for delegated access permissions. The detonation service 402 can receive the delegated access link on behalf of the user 202. Additionally, the detonation service 402 can be configured to consent to the application via the delegated access link. The identity provider laboratory tenant 404 can be included in an enterprise identity service or a laboratory account in another form of identity service such as social media site. The security monitor service 406 can be configured to detect malicious activity and to generate signals of malicious activity that may include reasons for alert for applications corresponding delegated access links. In one example, features of the security monitor service can be implemented with a cloud access security broker. The databased 408 can store the links and corresponding verdicts on the links based on whether malicious activity is detected with the security monitor service 406. In one example, the database 408 can include a denylist and may include a passlist of links corresponding with applications that have been included in the system 400.

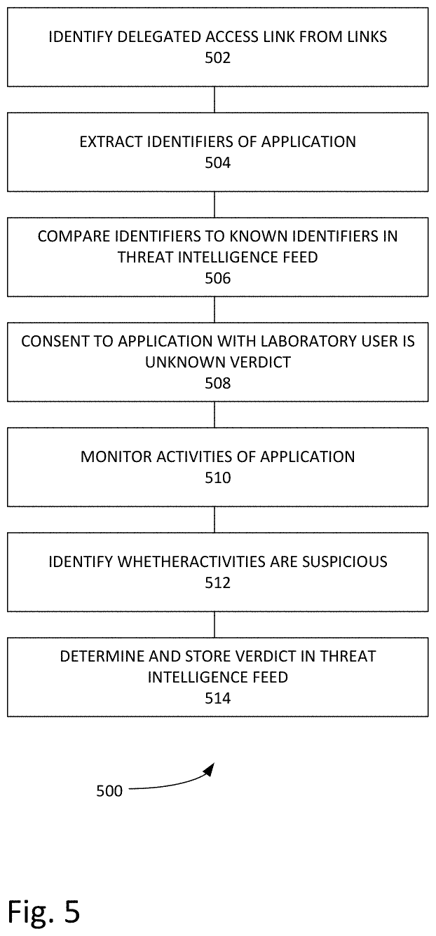

FIG. 5 illustrates an example method 500 provided by system 400 or security service 220. For example, the system 400 can include a computer readable storage device to store computer executable instructions to control a processor, such as a server in a datacenter. In one example, method 500 can be implemented as a computer program to run a processor as part of a server, such as a server included in system 400.

In one example, a communication with a delegated access link to an application from a third party is provided to a user of an identity provider that is running system 400 and is received by the system. In one instance, the delegated access link is extracted. For example, all links in the communication are extracted, and the system identifies a delegated access link associated with the identity provider at 502. Identifiers of the application from the third party are also extracted at 504, such as identifiers of the application are determined from the information in the communication. The identifiers of the application are compared to a known identifiers in a threat intelligence feed, such as in the database 408, to determine a verdict on the application at 506. The known identifiers are associated with verdicts such as prohibit access or permit access. If the verdict is unknown, such as the identifier of the application is not present in the threat intelligence feed, the system 400 can consent to the application via the delegated access link with a laboratory user established, for example, in the identity provider at 508. Features 502, 504, 506 and 508 can be implemented with the detonation service 402.

Activities of the application are monitored in in the laboratory user at 510. For example, the laboratory user can generate a set of logs of activities. Logs can include security policy logs and rights management logs that tract activities based on established security policies and whether files or documents are being manipulated. Additionally, events of the identity provider are tracked. An example security policy configured to monitor activities can monitor the data to detect a mass download activity in by the laboratory user, which may raise a presumption of a behavior to exfiltrate as much data as possible. In another example, documents in the security service may include in the account of laboratory user, such as word processing documents or other filed, are monitored to detect whether the file type has been changed. For instance, an online word processing documents are being changed from their original file type of “.docx” to “.doc” can violate a security policy in the laboratory user. A file type change can be for the purposes of downgrading to a file types that support VB (visual basic) code execution mechanism. VB code may serve adversaries in further lateral movement steps. Suspicious activities, such as those running afoul of security policies or violations of rights management policies, are identified at 512.

Activities of the application are monitored to determine a verdict at 514. In one example, the activities are tracked for a period of time to determine whether no suspicious activities are identified. If a suspicious activity, or a threshold amount of suspicious activities occur during the time period, a verdict is created and stored in the threat intelligence feed. If the time period passes without a suspicious activity or a threshold amount of suspicious activities, another verdict is created and stored in the threat intelligence feed. An identifier of the application or links associated with the communication, for example, can be stored in the threat intelligence feed, such as in database 408 and associated with the verdict at 514.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method, comprising:
receive an application via delegated access link provided to a user;
determine a verdict on the delegated access link;
if the verdict on the delegated access link is unknown:
open the application in a laboratory user based on the user, and
monitor activities of the application; and
assign a verdict on the delegated access link based on whether monitored activities include suspicious activities.

2. The method of claim 1 wherein the user includes a user of an identity service.

3. The method of claim 2 wherein the laboratory user is created in the identity service.

4. The method of claim 2 wherein the identity service is a delegated access provider.

5. The method of claim 4 wherein the user has a client account with the delegated access provider.

6. The method of claim 1 wherein verdicts on the delegated access link include prohibit access to link and unknown.

7. The method of claim 6 wherein the verdicts on the delegated access link further include permit access to link.

8. The method of claim 1 wherein the delegated access link includes authorization protocols or authentication protocols.

9. The method of claim 1 wherein suspicious activities are determined via a security policy.

10. The method of claim 9 wherein suspicious activities are determined via a rights management policy.

11. A computer readable storage device to store computer executable instructions to control a processor to:
receive an application via delegated access link provided to a user;
determine a verdict on the delegated access link;
if the verdict on the delegated access link is unknown:
open the application in a laboratory user based on the user, and
monitor activities of the application; and
assign a verdict on the delegated access link based on whether monitored activities include suspicious activities.

12. The computer readable storage device of claim 11 wherein the delegated access link is provided to the user via an electronic communication.

13. The computer readable storage device of claim 11 wherein the verdict is selected from a prohibit access to the link verdict that will not permit authorization of the delegated access link, a permit access to the link verdict that will provide authorization, and an unknown verdict.

14. The computer readable storage device of claim 11 wherein activities are monitored based on a security policy.

15. A system, comprising:
a memory device to store a set of instructions; and
a processor to execute the set of instructions to:
receive an application via delegated access link provided to a user;
determine a verdict on the delegated access link;
if the verdict on the delegated access link is unknown:
open the application in a laboratory user based on the user, and
monitor activities of the application; and
assign a verdict on the delegated access link based on whether monitored activities include suspicious activities.

16. The system of claim 15 wherein the verdict is assigned to a database and verdict is determined from the database.

17. The system of claim 15 wherein the application opened in the laboratory user includes the application consented to by the laboratory user and the application is run.

18. The system of claim 15 wherein the user includes a client account in an enterprise identity service to provide delegated access to the application.

19. The system of claim 15 wherein the activities are monitored with a cloud access security broker.

20. The system of claim 15 included in a cloud-based environment.
